(19) United States
(12) Patent Application Publication
(10) Pub. No.: US 2013/0234614 A1
(43) Pub. Date: Sep. 12, 2013

(54) REPLACEABLE ELECTRICAL BALLAST TUBE

(71) Applicants: Chung-Hung Yu, New Taipei City (TW); Hsuan-Hui Chen, New Taipei City (TW); Hao-Jan Fu, New Taipei City (TW); Chin-Tsai Liu, New Taipei City (TW)

(72) Inventors: Chung-Hung Yu, New Taipei City (TW); Hsuan-Hui Chen, New Taipei City (TW); Hao-Jan Fu, New Taipei City (TW); Chin-Tsai Liu, New Taipei City (TW)

(73) Assignee: JUSTENERGY TECHNOLOGY CORP., New Taipei City (TW)

(21) Appl. No.: 13/454,576

(22) Filed: Apr. 24, 2012

(30) Foreign Application Priority Data
Mar. 7, 2012 (TW) 101107636

(51) Int. Cl. H05B 37/00

(52) U.S. Cl. 315/201

(57) ABSTRACT

A replaceable electrical ballast tube is disclosed to be applied to a lamp holder with an electrical ballast. The tube includes a capacitor, a rectifier, a current limiting unit and a light-emitting module. The capacitor is connected in parallel with the electrical ballast to filter an AC voltage generated by the electrical ballast with high frequency and high voltage. The rectifier is connected in parallel with the capacitor to rectify the AC voltage to a DC voltage. The current limiting unit converts the DC voltage to a corresponding DC current. The DC current is provided to the light-emitting module to generate light. Accordingly, the tube can be directly used in the lamp holder of a traditional fluorescent lamp without changing the wiring of the lamp holder.

### FIELD OF THE INVENTION

The present invention relates to a replaceable electrical ballast tube, especially a light-emitting diode (LED) tube that can be applied to traditional lamp holders equipped with electrical ballasts.

### BACKGROUND OF THE INVENTION

After decades of research and experimental development, the manufacturing technology of LED has been profoundly enhanced. LED has been widely applied to replace the traditional fluorescent tube as a new light source in various fields because of its advantages of small size, pollution-free, effective energy-saving, long life, and high luminous efficiency. Currently, a LED module disposed in a transparent tube is utilized mostly as the structure of the LED devices available in the market, and the plug connector design of the fluorescent tubes in the related arts is used as the plug connector of the LED devices.

Currently, the traditional fluorescent tubes installed in modern buildings utilize traditional electrical ballasts tube to generate high resonant frequency and provide a sufficiently high starting voltage. However, when a LED tube is installed in the traditional fluorescent lamp, the high starting voltage generated by the resonance may lead to collapsing and burning of the LED. Therefore, the LED tube is not compatible to be applied directly to the traditional fluorescent lamp with the traditional electrical ballast. The starting method and frequent switching on and off also causes the two ends of the fluorescent tube to be blackened, leading to shorter life and lower luminous efficiency of the fluorescent lamp. If it is necessary to apply the LED to traditional lamps with traditional electrical ballasts, the electrical ballasts in the lamps must be removed, and the wiring of the lamps must be rearranged. This may create inconvenience of consumers and a barrier of promoting energy saving and green energy.

The inventor of the present invention had unearthed the shortcomings of the incompatibility between traditional light-emitting tubes and electrical ballast in related arts, and therefore invented a replaceable electrical ballast tube.

### SUMMARY OF THE INVENTION

An objective of this invention is to provide a replaceable electrical ballast tube which allows the LED tube to be installed directly in traditional fluorescent lamp holders.

Another objective of this invention is to install capacitors with high capacity in the replaceable electrical ballast tube to filter out high frequency and high AC voltage generated by the fluorescent lamp holders.

To achieve the goal mentioned above, this invention provides a replaceable electrical ballast tube, which is applied to lamp holders that comprises an electrical ballast, a capacitor, a rectifier, a current-limiting unit, and a light-emitting module. The capacitor is connected in parallel with the electrical ballast to filter out an AC voltage with high frequency and high voltage. The rectifier is connected in parallel with the capacitor to rectify the AC voltage to a DC voltage. The current-limiting unit is connected with the rectifier and generates a corresponding DC voltage according to the DC current. The light-emitting module is connected with the current-limiting unit and the rectifier to generate light in receiving the DC current.

Compared with related arts, the replaceable electrical ballast tube of the present invention can be installed directly on traditional fluorescent lamp holders and be compatible to the electrical ballast in the lamp holders. Accordingly, there is no need to purchase a new compatible lamp, to uninstall the electrical ballast, or to rearrange the wiring.

### BRIEF DESCRIPTION OF THE DRAWINGS

FIG. 1 is a schematic diagram of the circuit structure of resonant electronic ballast connected in series in related arts;

FIG. 2 is another schematic diagram of the circuit structure of resonant electronic ballast connected in series in related arts; and

FIG. 3 is a schematic diagram of an embodiment of the circuit of the replaceable electronic ballast tube.

### DETAILED DESCRIPTION OF THE INVENTION

The present invention provides a replaceable electronic ballast tube, which can be applied to lamp holders equipped with electronic ballast in related arts. In order to understand the goals, characteristics, and functions of this invention, the following embodiments and examples are revealed with the reference to figures to explain the concept of the invention specifically in detail.

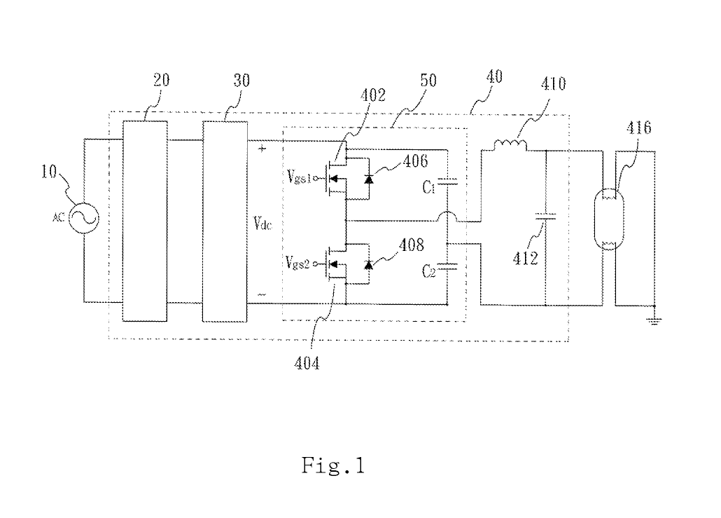

Firstly, referring to FIG. 1, which is a schematic diagram of the circuit structure of resonant electronic ballast connected in series in related arts, this figure shows that the resonant electronic ballast in series receives AC voltage generated by AC power (10). The AC voltage is further transferred to ballast rectifying unit (20). The AC voltage generates a DC voltage after being rectified by the ballast rectifying unit (20) and the DC voltage is provided to a power factor corrector (30). The power factor corrector (30), which is a DC to DC converting circuit, can control the timing of switch-on or switch-off according to various loads of different power to save or release energy from energy-saving circuit to further manipulate input power and waveform of the current. By a proper procedural process, the waveform and amplitude of the output current can be precisely controlled to achieve the functions of power factor correction and voltage stabilization. The power factor correction circuit developed by nowadays techniques working from tens to hundreds of kHz can suppress the harmonic distortion to almost zero and the power factor close to 1, and allows input power and load vary in a wide range. Additionally, the output DC voltage from the power factor corrector (30) is sent to the resonant inverter (50).

The resonant inverter (50) includes a first N-type MOS transistor (402), a second N-type MOS transistor (404), a first capacitor C1 and a second capacitor C2. The first N-type MOS transistor (402) is connected in parallel with the first diode (406). The second N-type MOS transistor (404) is connected in parallel with the second diode (408). The first capacitor C1 of the resonant inverter (50) is connected in between the drain of the first N-type MOS transistor (402) and the second capacitor C2 of the resonant inverter (50). The second capacitor C2 of the resonant inverter (50) is connected in between the first capacitor C1 of the resonant inverter (50) and the source of the second N-type MOS transistor (404). The two N-type MOS transistors (402, 404) of the resonant inverter (50) are switches.

Furthermore, the first N-type MOS transistor gate signal V_{gs1} and the second N-type MOS transistor gate signal V_{gs2} generate square-wave voltage by driving each other to conduction. The first capacitor C1 and the second capacitor C2 of the resonant inverter (50) have the function of filtering waves and the capacitance is considerable so that square-wave voltage can be seen as a source with constant voltage.

The duty cycles of the first N-type MOS transistor gate signal V_{gs1} and the second N-type MOS transistor gate signal V_{gs2} are usually symmetrically set to 50% and the dead-time between the first N-type MOS transistor gate signal V_{gs1} and the second N-type MOS transistor gate signal V_{gs2} is quite short to avoid two switches being conducted simultaneously to form collapse and being burned down. When the first N-type MOS transistor (402) is conducted, a first input voltage Vdc is set across both ends of the second N-type MOS transistor (404). Oppositely, when the second N-type MOS transistor (404) is conducted, the first input voltage Vdc is set across both ends of the first N-type MOS transistor (402).

The energy of the first capacitor C1 and the second capacitor C2 of the resonant inverter (50) is released according to the dead-time of driving signals of the two switches. When the voltage of the switch drops down to zero, the switches are conducted in other to achieve zero-voltage switching and higher efficiency. Therefore, the resonant inverter (50) converts the first input voltage Vdc of the power factor corrector (30) into high-frequency square-wave voltage and current according to by two active switching components (402, 404).

The fluorescent tube (416), which is driven by resonant circuit inductor (410) and resonant circuit capacitor (412), is an electrical load and outputs high-frequency voltage through high-frequency switching of the resonant inverter (50) where the resonant circuit inductor (410) and the resonant circuit capacitor (412) can be regarded as the aforementioned resonant circuit. This resonant circuit have two functions of providing starting voltage of fluorescent tube (416) while starting and providing appropriate filament current while the fluorescent tube (416) works at steady state.

The capacitance of an electronic ballast (40) is generally set as about 33 to 47 nF and the inductance is about 0.2 to 0.3 mH. The resonance frequency f is about resonant inverter (50) kHz according to the formula of LC series resonance which shows as following while the general electronic ballast (40) works about from 20 to 70 kHz.

$$f = \frac{1}{2 π \sqrt{LC}}$$

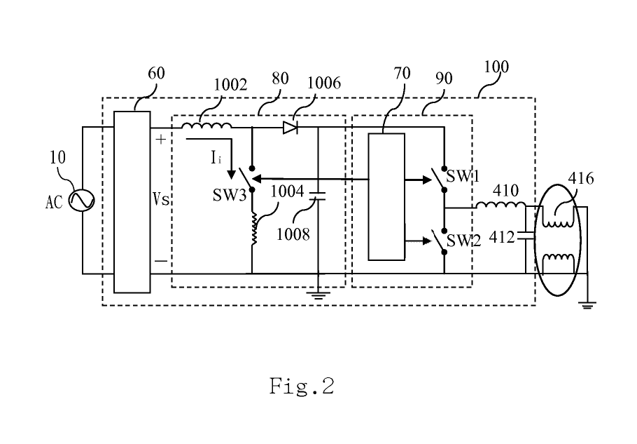

Referring to FIG. 2, which is another schematic diagram of the circuit structure of resonant electronic ballast connected in series in related arts, the AC power (10) outputs AC voltage to the ballast rectifying circuit (60). The DC voltage which is rectified from the AC voltage is sent to a power factor corrector (80). The power factor corrector (80) is a DC-to-DC converting circuit which can determine the timing of switching on/off according to various loads of different power to save or release energy from energy-saving circuit to further manipulate input power and waveform of current.

When a control circuit unit (70) conducts a third switch SW3, a third diode (1006) cuts off due to reverse bias. The load energy is provided by a first capacitor (1008). Ii flows through a first inductor (1002), the third switch SW3 and a resistance (1004), and the output end of the ballast rectifying circuit (60) and forms a charging circuit to the first inductor (1002). The first inductor (1002) therefore starts storing energy. The current of the first inductor (1002) increases linearly. When the control circuit unit (70) cuts off the third switch SW3, the current of the first inductor (1002) cannot change instantaneously, so the forward bias of the third diode (1006) provides a path to the current of the first inductor (1002). The polarity of voltage across the first inductor (1002) becomes negative due to back electromotive force, so the current of the first inductor (1002) decreases linearly and provides energy to the first capacitor (1008) with second input voltage Vs. The waveform and the amplitude of the current can thereby be precisely determined to achieve the functions of power factor correction and voltage stabilization.

The DC voltage outputted by the power factor corrector (80) is sent to a resonant inverter (90) of a power factor corrector (100), which includes a first switch SW1 and a second switch SW2. One end of the first switch SW1 and the first capacitor (1008) are electrically connected and the other end is electrically connected with the second switch SW2. One end of the second switch SW2 is electrically connected with the first switch SW1 and the other end is electrically connected with output end of the power factor corrector (80) (which is not shown in figures). The working principle of the circuit mentioned above is the same as the resonant inverter (50) in the embodiment mentioned above except that the resonant inverter (90) determines whether to turn on/off the first switch SW1 and the second switch SW2 according to control circuit unit (70).

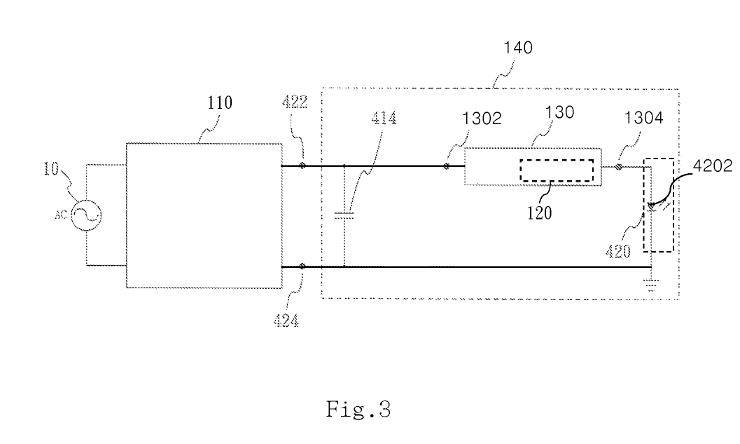

Referring to FIG. 3, which is a schematic diagram of an embodiment of the circuit of the replaceable electronic ballast tube, the circuit and working principle of the electronic ballast (110) can be the same as at least one of what are described in FIG. 1 or FIG. 2. What differs in this embodiment is to replace the fluorescent tube (416) by a replaceable electronic ballast tube (140) of this invention.

In addition, the replaceable electronic ballast tube (140) further includes a capacitor (414), a rectifier (120), a current-limiting unit (130), and a light-emitting module (420). The capacitor (414) is connected between a first lamp contact spot (422) and a second lamp contact spot (424) of a lamp holder equipped with the electronic ballast (110). The capacitor (414) can be one of an electrolytic capacitor, a metal-oxide-semiconductor (MOS) transistor capacitor, and a ceramic capacitor. The capacitance of the capacitor (414) can be about 1 to 4.7 nF and filter out high voltage and high-frequency oscillation generated by the electronic ballast (110) while starting according to the characteristic of that operation under high-frequency AC can be regarded as short circuit and that operation under DC can be regarded as open circuit, in order to output DC voltage from 110 V to 600 V to drive light-emitting elements working normally.

The rectifier (120) is connected between the first lamp contact spot (422) and the second lamp contact spot (424). As shown in FIG. 3, the rectifier (120) can be regarded as connected in parallel with the capacitor (414). The rectifier (120) can rectify the sinusoidal voltage of the electronic ballast (40) to DC voltage. In one practical embodiment, the rectifier (120) can be a full-bridge rectifier comprised by multiple diodes. Each diode can be high-frequency diode so that the DC voltage becomes bearable and the AC voltage can be separated from the DC current.

An input (1302) of the current-limiting unit (130) is connected with the rectifier (120). Output (1304) of the current-limiting unit (130) is connected with the light-emitting module (420). In addition, the current-limiting unit (130) generates a DC current according to the DC voltage of the rectifier (120). The other end of the light-emitting module (420) is connected with the rectifier (120) and produce a corresponding light source according to the DC current received. The light-emitting module (420) comprises at least one light-emitting unit (4202). The light-emitting unit (4202) is one of an organic LED, a LED, or an electroluminescent LED. In another embodiment, the light-emitting module (420) can be connected with multiple light-emitting units (4202) in series, in parallel, or in series and in parallel. In this embodiment, the light-emitting module (420) is, for example, a single light-emitting unit (4202).

In this embodiment, the equivalent capacitance of the electronic ballast (110) changes because the capacitor (414) and the resonant circuit capacitor (412) of the electronic ballast (110) are connected in parallel as shown in FIG. 1 and FIG. 2. According to the Equivalent capacitance's characteristic of that operation under high-frequency AC voltage can be regarded as short circuit and that operation under DC voltage can be regarded as open circuit, damages of instantaneous oscillation of high voltage and high frequency are slowed down while the electronic ballast (110) starts. A rated operating voltage which suits the light-emitting module (420) is thereby outputted from 100V to 600V in order to drive light-emitting tubes working normally and avoid the phenomena of collapse and being burned down of the light-emitting unit (4202).

The preferred embodiments of the present invention have been disclosed in the examples. However the examples should not be constructed as a limitation on the actual applicable scope of the invention, and as such, all modifications and alterations without departing from the spirits of the invention and appended claims shall remain within the protected scope and claims of the invention.

What is claimed is:

1. A replaceable electrical ballast tube to be applied to a lamp holder with an electrical ballast, the replaceable electrical ballast tube comprising:
a capacitor connected in parallel with the electrical ballast to filter an AC voltage generated by the electrical ballast with high frequency and high voltage;
a rectifier connected in parallel with the capacitor to rectify the AC voltage to a DC voltage;
a current limiting unit connected with the capacitor to convert the DC voltage to a corresponding DC current; and
a light-emitting module connected with the current limiting unit and the rectifier to generate light in receiving the DC current.

2. The replaceable electrical ballast tube according to claim 1, wherein the capacitor is at least one of an electrolytic capacitor, a metal-oxide-semiconductor (MOS) transistor capacitor, and a ceramic capacitor.

3. The replaceable electrical ballast tube according to claim 1, wherein the rectifier further includes a bridge rectifier comprising a plurality of high frequency diodes to isolate the AC voltage from the DC current.

4. The replaceable electrical ballast tube according to claim 1, wherein the light- emitting module comprises at least one light-emitting unit, and the at least one light-emitting unit comprises one of an organic light-emitting diode, a light-emitting diode, and an electroluminescent light-emitting diode.

5. The replaceable electrical ballast tube according to claim 4, wherein the light-emitting module is formed by connecting in series, in parallel, or in series and in parallel with a plurality of the light-emitting units.
